(19) United States
(12) Patent Application Publication
(10) Pub. No.: US 2002/0087435 A1
(43) Pub. Date: Jul. 4, 2002

(54) Presentation material publishing system, presentation material publishing server, presentation material publishing method, and presentation material publishing program storage medium

(76) Inventors: Hideo Neishi, Kanagawa (JP); Shinji Kaneko, Chiba (JP); Kenji Kasahara, Tokyo (JP)

Correspondence Address: William S. Frommer, Esq., FROMMER LAWRENCE & HAUG LLP, 745 Fifth Avenue, New York, NY, 10151, US

(21) Appl. No.: 09/998,149

(22) Filed: Nov. 30, 2001

(30) Foreign Application Priority Data
Dec. 1, 2000 (JP) 2000-367549

(51) Int. Cl. G06F 17/60

(52) U.S. Cl. 705/27

(57) ABSTRACT

A system capable of public presentation materials making in a publishing server is provided. A presentation material publishing system includes a presenter, a reader, and a presentation material publishing server which can be accessed by the presenter and the reader via a network. The presentation material publishing server makes public presentation materials which are uploaded from the presenter on condition of the registration of predetermined public information. The reader can browse the presentation materials permitted by the presentation material publishing server via the network.

### BACKGROUND OF THE INVENTION

1. Field of the Invention

The present invention relates to a presentation material publishing system, etc., for assisting people or corporations with creating presentation materials which are made public on a network, such as the Internet.

2. Description of the Related Art

In recent years, in various business situations, personal computers have been used. As an example thereof, a method has been widely used in which presentation materials inside or outside a company are created by using presentation material publishing software, such as, for example, PowerPoint of Microsoft Corporation, Freelance of Lotus Development Corporation, or Acrobat of Adobe Systems Incorporated, so that these effectively appeal to a person who reads them while giving a strong impression.

When a live presentation is to be performed using presentation materials, various methods have been adopted. For example, when a presentation is performed in front of a plurality of viewers, it is in common practice that a liquid-crystal projector, etc., is connected to a computer in which presentation materials are stored, so that the contents of the presentation materials are displayed on the screen, or the contents of the presentation materials which are printed using a printer are distributed.

Furthermore, another method is also commonly performed in which presentation materials are stored in advance on a WWW (World Wide Web) server managed by the presenter, and a reader who requires those presentation materials accesses that WWW server and browses them.

However, when a presentation is performed in a lecture hall, a computer and various types of storage media, such as or magneto-optical disks (MOs), in which presentation materials are stored, must be brought with oneself, and very complicated operations, such as adjusting the peripheral devices disposed in the meeting room so as to be compatible, are necessary. Furthermore, if the presentation material file is destroyed, such as when a hard disk crashes, a case arises in which the presentation cannot be performed. Therefore, there is a technical demand for freely acquiring and using the presentation materials by using devices disposed at the presentation site.

When presentation materials are printed and distributed, most of the presentation materials are often discarded after the presentation, and thus paper resources are wasted. Also, when the presentation materials are used later, for the printed materials, there is a limitation in the method of using them, presenting the problem that digitized information resources cannot be effectively used. Therefore, there is a technical demand that presentation information produced as digital information is distributed while being kept as digital information and is effectively used, and at the same time, paper resources are saved.

Also, in the WWW server managed by the presenter, in the method in which presentation materials are stored and the reader who has accessed them is allowed to browse them, the management of the presentation materials is complicated, and dealing with an end user is not possible. When a large number of readers have come to access and browse the presentation materials, there is also a risk that traffic congestion occurs, and other functions of the WWW server are hindered.

### SUMMARY OF THE INVENTION

The present invention has been made to overcome the above-described and other problems of the related art.

In this specification, the “presenter” refers to not only a person or an organization such as a corporation, which is a sender of a presentation, which simply creates presentation materials, but also a terminal device, such as a computer, belonging to such a sender. In a similar manner, in this specification, the “reader” refers to not only a person or an organization such as a corporation, which is a receiver which simply receives the distribution of presentation materials, but also to a terminal device, such as a computer, belonging to such a receiver. In particular, in this specification, when the term “presenter” or “reader” is used in association with the elements which constitute the present invention, unless particularly specified, it refers to a terminal device, such as a computer, which can be connected to a network, having functions as “presenter” or a “reader” (to be described later).

To solve the above-mentioned problems, according to one aspect of the present invention, there is provided a presentation material publishing system comprising: a presenter; a reader; and a presentation material publishing server which can be accessed by the presenter and the reader via a network, wherein the presentation material publishing server can store presentation materials uploaded from the presenter via the network in such a manner as to be associated with public information, and has the right to permit the browsing of the presentation materials by the reader which has come to access them via the network, the presenter can register predetermined public information in the presentation material publishing server via the network and can upload the presentation materials in such a manner as to be associated with the public information, and the reader can browse the presentation materials permitted by the presentation material publishing server via the network.

Here, the “presentation materials” which are objects of services of the presentation material publishing system in accordance with the present invention are a presentation file composed of template information, image information, text information, etc., which can be created using presentation material publishing software, such as, for example, PowerPoint of Microsoft Corporation, Freelance of Lotus Development Corporation, or Acrobat of Adobe Systems Incorporated.

Among clients who access the presentation material publishing server via a network, the “presenter” is defined as a client such that authorization for receiving presentation material publishing services provided by the presentation material publishing server is authenticated. Therefore, generally, the presenter is a computer having functions provided in the client, that is, a communication function, a browser function, etc., and the presenter also includes a home electric appliance, a portable terminal device, etc., having functions as a client.

Among clients who access the presentation material publishing server via a network, the “reader” is defined as a client such that the authority for browsing the presentation materials which are made public by the presentation material publishing server is authenticated. Therefore, generally, the reader is a computer having functions provided in the client, that is, a communication function, a browser function, etc., and the reader also includes a home electric appliance, a portable terminal device, etc., having functions as a client.

Furthermore, the term “browse” used in this specification should be construed as the most broadest meaning, and all cases in which the reader reaches a state to be capable of browsing the presentation materials are included. Therefore, not only cases in which the reader simply accesses the presentation material publishing server and directly browses the presentation materials are included, but also cases in which the presentation materials are directly downloaded from the presentation material publishing server, and furthermore, the presentation materials are distributed from the presentation material publishing server by means such as mail via a network are included.

It is assumed that the functional construction of the components of the invention, defined here, is applied to the components of the other aspects of the invention unless otherwise specified.

The “network” is a communication network, by which two-way communication of information is possible, such as the Internet connected via a public network, or an intranet connected via a LAN (Local Area Network), and it does not matter whether the network is formed wirelessly or by wire.

The “presentation material publishing server” is a computer apparatus which forms a WWW server capable of providing presentation material publishing services to a presenter, a reader, or other clients via a network. In particular, it should be noted that the features of the present invention are in that the presentation material publishing server is not a server which is unique to a presenter so that the presentation materials are developed on the site of the presenter as in the conventional case, but a publishing server which can be shared among a plurality of servers.

In the manner described above, according to the present invention, since presentation materials can be uploaded into the presentation material publishing server, the presentation materials can be efficiently distributed. At this time, since the presentation material publishing server is formed as a publishing server shared among a plurality of presenters, even if there are many accesses, no burden is imposed on the server of the presenter.

Furthermore, since public information such as the presentation time is registered in advance, the labor of making the presentation materials public by the presenter can be omitted.

If category information of presentation materials is contained in public information and the presentation materials are classified according to the category information and are made public, the convenience for users, such as readers, can be improved.

If the browsing permission information for a reader is incorporated into the public information and only the browsing of the reader who matches this browsing permission condition is permitted, the construction such that, also for presentation materials having a high level of secrecy, the presentation materials are distributed to only a reader having an access right for the secrecy can be adopted.

Preferably, the presentation material publishing server notifies the presenter of estimate information on the basis of the public information registered by the presenter. Furthermore, preferably, the presentation material publishing server performs a credit process for the presenter before the uploading of the presentation materials by the presenter is permitted. When the credit process is approved, preferably, the presentation material publishing server notifies the uploading target address of the presentation materials.

According to another aspect of the present invention, there is provided a presentation material publishing server comprising: a storage device capable of storing presentation materials uploaded from a presenter via a network in such a manner as to be associated with public information, and a browsing permission device having a right of permitting the browsing of the presentation materials by a reader which has accessed them via a network.

According to another aspect of the present invention, there is provided a presentation material publishing program storage medium by which a computer forms the above-described presentation material publishing server.

According to another aspect of the present invention, there is provided a presentation material publishing method comprising: a step in which a presenter accesses a presentation material publishing server via a network and uploads presentation materials in the presentation material publishing server via the network; a step of storing the uploaded presentation materials in such a manner as to be associated with public information; and a step of permitting the browsing of presentation materials by a presenter which has accessed the presentation material publishing server via the network.

Further objects, features and advantages of the present invention will become apparent from the following description of the preferred embodiments with reference to the attached drawings.

### BRIEF DESCRIPTION OF THE DRAWINGS

FIG. 1 is a block diagram showing the construction of a presentation material publishing system according to an embodiment of the present invention;

FIG. 2 is a block diagram showing the construction of a presenter of the presentation material publishing system according to the embodiment of the present invention;

FIG. 3 is a block diagram showing the construction of a reader of the presentation material publishing system according to the embodiment of the present invention;

FIG. 4 is a block diagram showing the construction of a presentation material publishing server of the presentation material publishing system according to the embodiment of the present invention;

FIG. 5 is a flowchart showing a presentation material publishing flow of the presentation material publishing system according to the embodiment of the present invention;

FIG. 6 is a flowchart showing an order-receiving flow of the presentation material publishing system according to the embodiment of the present invention;

FIG. 7 is a flowchart showing a presentation material downloading flow of the presentation material publishing system according to the embodiment of the present invention;

FIG. 8 is an illustration of a presentation material management structure of the presentation material publishing system according to the embodiment of the present invention;

FIG. 9 is a flowchart showing a membership registration screen flow of the presentation material publishing system according to the embodiment of the present invention;

FIG. 10 is an illustration showing a browser display screen of a site for providing presentation material publishing services according to the embodiment of the present invention;

FIG. 11 is an illustration showing a browser display screen of a site for providing presentation material publishing services according to the embodiment of the present invention;

FIG. 12 is an illustration showing a browser display screen of a site for providing presentation material publishing services according to the embodiment of the present invention;

FIG. 13 is an illustration showing a browser display screen of a site for providing presentation material publishing services according to the embodiment of the present invention;

FIG. 14 is an illustration showing a browser display screen of a site for providing presentation material publishing services according to the embodiment of the present invention;

FIG. 15 is an illustration showing a browser display screen of a site for providing presentation material publishing services according to the embodiment of the present invention;

FIG. 16 is a flowchart showing a presentation material uploading screen of the presentation material publishing system according to the embodiment of the present invention;

FIG. 17 is an illustration showing a browser display screen of a site for providing presentation material publishing services according to the embodiment of the present invention;

FIG. 18 is an illustration showing a browser display screen of a site for providing presentation material publishing services according to the embodiment of the present invention;

FIG. 19 is an illustration showing a browser display screen of a site for providing presentation material publishing services according to the embodiment of the present invention;

FIG. 20 is an illustration showing a browser display screen of a site for providing presentation material publishing services according to the embodiment of the present invention;

FIG. 21 is an illustration showing a browser display screen of a site for providing presentation material publishing services according to the embodiment of the present invention;

FIG. 22 is an illustration showing a browser display screen of a site for providing presentation material publishing services according to the embodiment of the present invention;

FIG. 23 is an illustration showing a browser display screen of a site for providing presentation material publishing services according to the embodiment of the present invention;

FIG. 24 is an illustration showing a browser display screen of a site for providing presentation material publishing services according to the embodiment of the present invention;

FIG. 25 is a flowchart showing an order-receiving screen flow of the presentation material publishing system according to the embodiment of the present invention;

FIG. 26 is an illustration showing a browser display screen of a site for providing presentation material publishing services according to the embodiment of the present invention;

FIG. 27 is an illustration showing a browser display screen of a site for providing presentation material publishing services according to the embodiment of the present invention;

FIG. 28 is an illustration showing a browser display screen of a site for providing presentation material publishing services according to the embodiment of the present invention;

FIG. 29 is an illustration showing a browser display screen of a site for providing presentation material publishing services according to the embodiment of the present invention;

FIG. 30 is an illustration showing a browser display screen of a site for providing presentation material publishing services according to the embodiment of the present invention;

FIG. 31 is an illustration showing a browser display screen of a site for providing presentation material publishing services according to the embodiment of the present invention;

FIG. 32 is an illustration showing a browser display screen of a site for providing presentation material publishing services according to the embodiment of the present invention;

FIG. 33 is an illustration showing a browser display screen of a site for providing presentation material publishing services according to the embodiment of the present invention;

FIG. 34 is an illustration showing a browser display screen of a site for providing presentation material publishing services according to the embodiment of the present invention;

FIG. 35 is an illustration showing a browser display screen of a site for providing presentation material publishing services according to the embodiment of the present invention;

FIG. 36 is an illustration showing a browser display screen of a site for providing presentation material publishing services according to the embodiment of the present invention;

FIG. 37 is an illustration showing a browser display screen of a site for providing presentation material publishing services according to the embodiment of the present invention;

FIG. 38 is an illustration showing a browser display screen of a site for providing presentation material publishing services according to the embodiment of the present invention; and

FIG. 39 is an illustration showing a browser display screen of a site for providing presentation material publishing services according to the embodiment of the present invention.

### DESCRIPTION OF THE PREFERRED EMBODIMENTS

With reference to the attached drawings, preferred embodiments of a presentation material publishing system, etc., according to the present invention will be described below in detail. In the following description and the attached drawings, components having substantially the same functional construction are given the same reference numerals, and accordingly, duplicate descriptions are omitted.

(1) Construction of Presentation Material Publishing System

(1-1) Overall Construction of the System

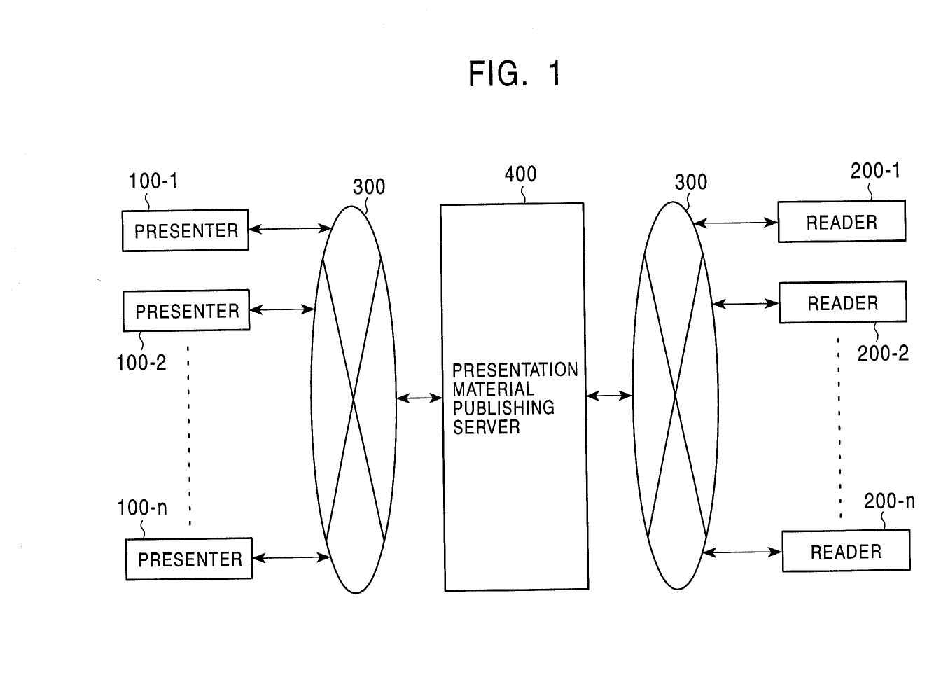

First, referring to FIG. 1, the overall construction of a presentation material publishing system according to this embodiment will be described.

As shown in FIG. 1, the presentation material publishing system according to this embodiment mainly comprises a plurality of presenters 100 (100-1, 100-2, . . . , 100-n) which are a group of users for the presentation material publishing services, a plurality of readers 200 (200-1, 200-2, . . . , 200-n) which are another group of users for the presentation material publishing services, and a presentation material publishing server 400, which is a provider of presentation material publishing services, which can be accessed by the presenter 100 and the reader 200.

(1-2) Presentation Materials

Here, the “presentation materials” which are objects of services of the presentation material publishing system according to this embodiment are a presentation file composed of template information, image information, text information, etc., which can be created using presentation material publishing software, such as, for example, PowerPoint of Microsoft Corporation, Freelance of Lotus Development Corporation, or Acrobat of Adobe Systems Incorporated.

The presentation materials are business tools such that various ideas of a presenter are efficiently put into order and tables are added as necessary so as to be easy to understand when presented. When it is required that points desired to be expressed be transmitted to the other party so as to be easy to understand, such as a speech at a meeting or in front of an audience, or distribution of a message via the Internet, a great success can be made by using the presentation materials.

The presentation materials can take various forms according to application software for creating the materials. However, the presentation material publishing system according to this embodiment can be applied regardless of the type of application software. That is, the presentation material publishing system according to this embodiment, as will be described later, divides the presentation materials into layout information and provides them. The layout information contains at least template information, and contains, as necessary, image material information, text information, and other pieces of information.

In this specification, the embodiment of the present invention is described based on a case in which presentation materials suitable for PowerPoint, which is a presentation tool made by Microsoft Corporation, are created. However, due to the above-described reasons, the present invention is not limited to such an example, and, of course, the present invention can provides layout information which can be applied to presentation materials for other presentation tools, such as Freelance of Lotus Development Corporation or Acrobat of Adobe Systems Incorporated.

(1-3) Presenter 100

The “presenter” 100 is a concept which is unique to this specification. Among clients which access the presentation material publishing server 400 via a network 300, the presenter 100 is defined as a client on the information sender side, in which the authority for receiving presentation material publishing services is authenticated. Therefore, generally, the presenter is a computer having functions possessed by the client, that is, a communication function, a browser function, etc., and the presenter also includes a home electric appliance, a portable terminal device, etc., having functions as a client.

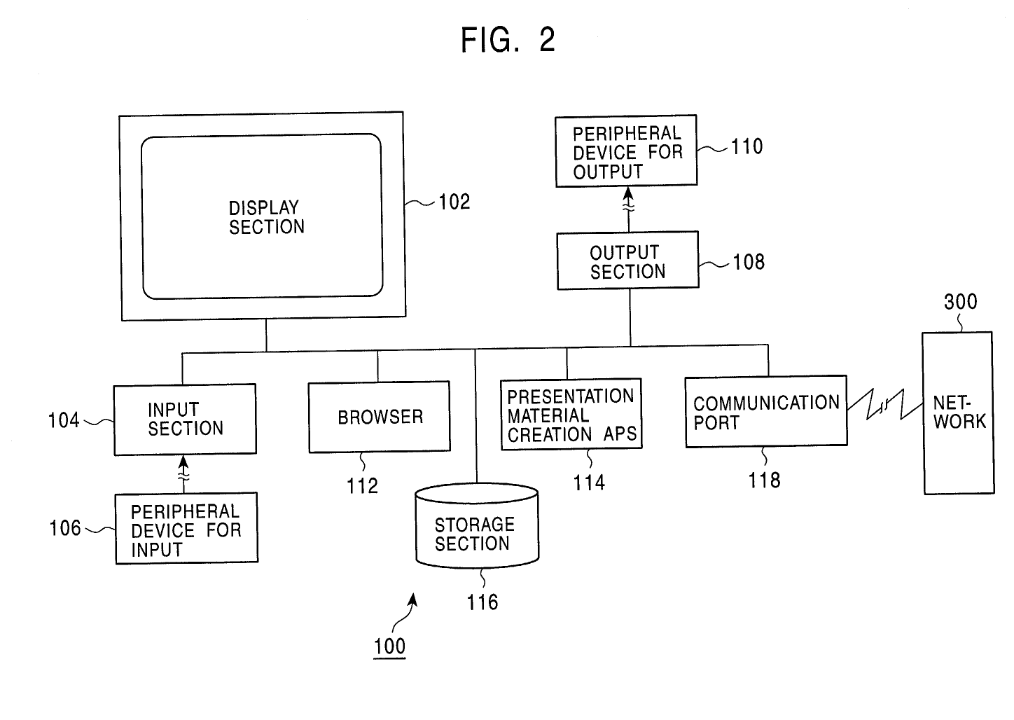

FIG. 2 shows an example of the construction of the presenter 100.

A display section 102 is a display device, such as a CRT or a liquid-crystal display, and displays presentation materials and other images to be uploaded into the presentation material publishing server 400. In the presentation material publishing services according to this embodiment, the display section 102 has a function of displaying a screen for uploading presentation materials as a result of being operated by a CGI (Common Gateway Interface), etc., transmitted from the presentation material publishing server 400.

An input section 104 is an input device, such as a keyboard or a mouse, for inputting information associated with presentation materials, and an external peripheral device 106 for input, such as a scanner, for inputting image information, can be connected as necessary. In the presentation material publishing system according to this embodiment, the input section 104 functions as an input editing device for creating presentation materials.

An output section 108 is a functional section for externally outputting a file such as presentation materials, and a peripheral device 110 for output, such as a printer for printing presentation materials for distribution or a projector for projecting presentation materials in a lecture hall, is connected as necessary.

A browser 112 is a functional section for displaying a Web page from a server connected via the Internet. That is, it is possible to display a Web page associated with the presentation material publishing server 400 in coordination with the display section 102.

Application software 114 for creating presentation materials, as has already been described, has a function of creating presentation materials by combining template information, image information, text information, etc., examples thereof being PowerPoint of Microsoft Corporation, Freelance of Lotus Development Corporation, and Acrobat of Adobe Systems Incorporated.

A storage section 116 has stored therein an OS, such as Windows of Microsoft Corporation or Linux, and various types of application software such as a presentation tool, and furthermore, can store presentation materials to be uploaded into the presentation material publishing server by the presentation material publishing system according to this embodiment.

A communication port 118 has a communication function, and is connected to the network 300 such as the Internet so that the use of the presentation material publishing system according to this embodiment becomes possible.

(1-4) Reader 200

The “reader” 200 is a concept which is unique to this specification. Among clients who access the presentation material publishing server 400 via the network 300, the “reader” 200 is defined as a client on the information receiving side such that the authority for receiving the presentation material publishing services is authenticated. Therefore, generally, the reader is a computer having functions possessed by the client, that is, a communication function, a browser function, etc., and the reader also includes a home electric appliance, a portable terminal device, etc., having functions as a client.

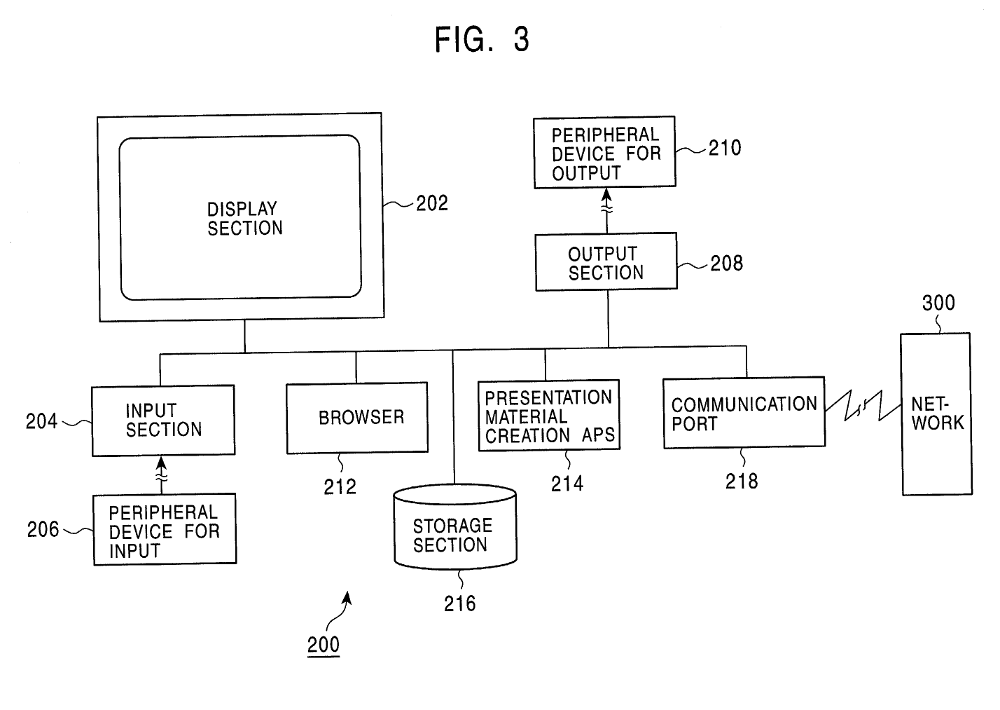

FIG. 3 shows an example of the construction of the reader 200.

A display section 202 is a display device, such as a CRT or a liquid-crystal display, and displays presentation materials and other images downloaded from the presentation material publishing server 400. In the presentation material publishing services according to this embodiment, the display section 102 has a function of displaying a screen for downloading presentation materials as a result of being operated by a CGI (Common Gateway Interface), etc., transmitted from the presentation material publishing server 400.

An input section 204 is an input device, such as a keyboard or a mouse, for inputting information associated with presentation materials, and an external peripheral device 206 for input, such as a scanner, for inputting image information, can be connected as necessary. In the presentation material publishing system according to this embodiment, the input section 204 functions as an input editing device for creating presentation materials.

An output section 208 is a functional section for externally outputting a file such as presentation materials, and a peripheral device 210 for output, such as a printer for printing presentation materials for distribution or a projector for projecting presentation materials in a lecture hall, is connected.

A browser 212 is a functional section for displaying a Web page from a server connected via the Internet. That is, it is possible to display a Web page associated with the presentation material publishing server 400 in coordination with the display section 202.

Application software 214 for creating presentation materials, as has already been described, has a function of creating presentation materials by combining template information, image material information, text information, etc., examples thereof being PowerPoint of Microsoft Corporation, Freelance of Lotus Development Corporation, or Acrobat of Adobe Systems Incorporated.

A storage section 216 has stored therein an OS, such as Windows of Microsoft Corporation or Linux, and various types of application software such as a presentation tool, and furthermore, can store presentation materials uploaded from the presentation material publishing server by the presentation material publishing system according to this embodiment.

A communication port 218 has a communication function, and is connected to the network 300 such as the Internet so that the use of the presentation material publishing system according to this embodiment becomes possible.

(1-4) Network 300

The “network” 300 is a communication network, by which two-way communication of information is possible, such as the Internet which is connected via a public network, etc., or an intranet which is connected via a LAN (Local Area Network), and it does not matter whether the network is formed wirelessly or by wire.

The “presentation material publishing server” 300 is a computer apparatus which forms a WWW (World Wide Web) server (or also referred to as a “Web server” or an “HTTP (Hypertext Transfer Protocol) server”) capable of providing presentation material publishing services according to this embodiment, to the presenter 100 and the reader 200 via the network 300.

(1-5) Presentation Material Publishing Server 400

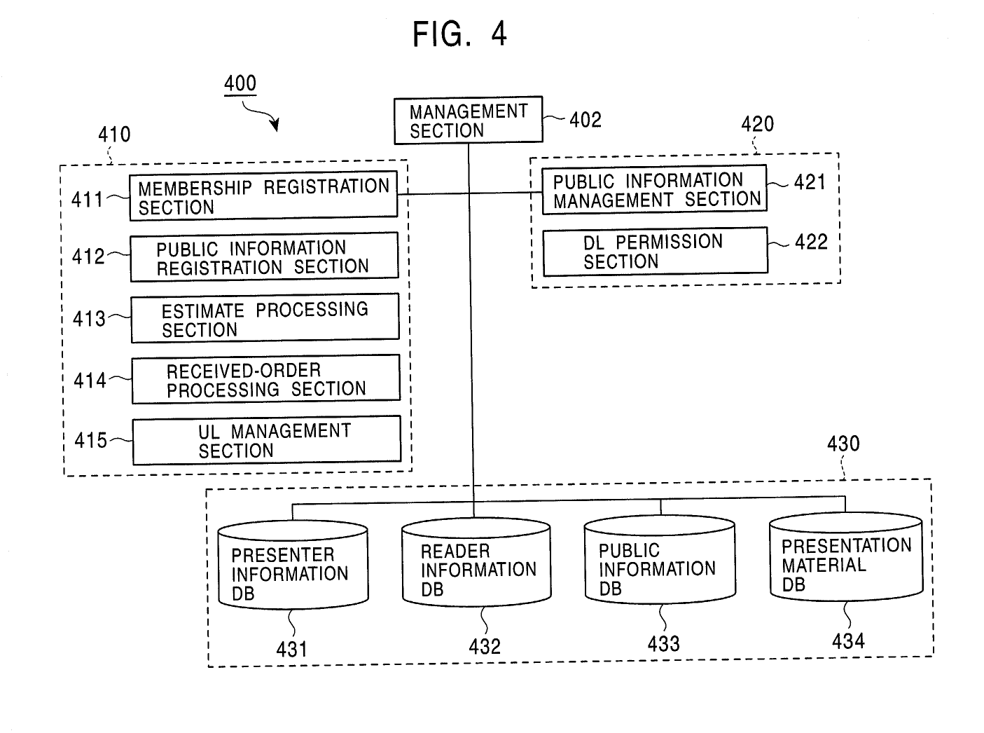

Next, the construction of the presentation material publishing server 400 will be described in detail with reference to FIG. 4.

As has already been described, the presentation material publishing server 400 is a computer apparatus which forms a WWW server capable of providing presentation material publishing services to the presenter 100, the reader 200, and other clients via the network 300.

The functional sections of the presentation material publishing server 400 mainly comprise a management section 402 for managing the overall operation of the presentation material publishing server 400, a presenter handling section 410 for managing the exchange of information with the presenter 100, a reader handling section 420 for managing the exchange of information with the reader 200, and a database section 430 for storing and managing various types of data.

The reader handling section 420 of the presentation material publishing server 400 further comprises a membership registration section 411, a public information registration section 412, an estimate processing section 413, an order-receiving processing section 414, and an upload management section 415.

The membership registration section 411 registers a member who uses the presentation material publishing services according to this embodiment in a presenter information database 431 of the presentation material publishing server 400 of the database section 430. Although the flow of the details of a membership registration process will be described later, in order to use the presentation material publishing services according to this embodiment, a membership registration is necessary in advance. In this manner, by making the membership registration necessary in advance, the number of accesses by an unserious user decreases, thus traffic congestion can be avoided. Furthermore, it becomes possible to use information of the membership registered herein in various situations, for example, during a credit process (to be described later), and information can be effectively used and system efficiency is improved.

In the public information registration section 412, public information, such as presentation material publishing conditions, which are made public by the presentation material publishing services according to this embodiment, is registered. The public information contains, for example, the presentation time of presentation materials, category information of presentation materials, and downloading permission information of a reader. The presentation material publishing server 400 determines the presentation cost based on these pieces of public information, makes them public, and permits the downloading by the reader 200.

The estimate processing section 413 has a function of displaying by using the CGI technique, etc., on the screen of the presenter 100, an estimate of a cost necessary for uploading the presentation materials and for making them public in the presentation material publishing server 400 on the basis of the public information which is registered in the public information registration section 412 by the presenter 100. By referring to such an estimate, the presenter 100 can determine whether the presenter 100 wants to make public the presentation materials even to the extent of paying the estimated cost or the presenter 100 should give up on making the presentation materials public.

The order-receiving processing section 414 has a function of presenting matters that require attention when using the presentation material publishing services according to this embodiment, or rules, such as agreement matters, and of temporarily order-receiving a request from the presenter 100 on condition of the consent to the rules. When temporarily receiving an order, the order-receiving processing section 414 requests a registration of detailed information about the presenter 100. This detailed information contains information necessary when a credit process (to be described later) is performed, for example, a credit card number, etc. The order-receiving processing section 414 performs a credit process on the basis of these pieces of detailed information in order to perform a credit check of the payment performance of the concerned presenter 100. In the manner described above, by performing a credit check prior to a formal order-receiving, an occurrence of a credit which cannot be collected can be avoided.

The upload management section 415 accepts the uploading of the presentation materials from the presenter 100 after a publishing request from the presenter 100 is formally received, stores the presentation materials at a predetermined address, and manages them.

The reader handling section 420 of the presentation material publishing server 400 comprises, as main functional sections, a public information management section 421 and a downloading permission section 422.

The public information management section 421 manages the public information registered in the public information registration section 412. For example, if a publication period is set, the presentation materials are made public only in the presentation time. Furthermore, it is possible to classify the presentation materials according to the registered category information and to present them to the reader 200. Furthermore, if the permission conditions by the reader 200 are set, management is performed so that only the downloading by the reader 200 which matches the permission conditions is permitted.

The downloading permission section 422 has an authority of determining the browsing request of the presentation materials from the reader 200 which has accessed the presentation material publishing server 400 and of permitting a downloading in accordance with the instructions of the public information management section 421.

The example shown in FIG. 4 shows a case in which the downloading of the presentation materials is set to be free of charge. However, when the downloading of the presentation materials is set to be chargeable, the construction may be formed in such a way that an order-receiving processing section 414 having substantially the same construction as the presenter handling section 410 is possessed by the reader handling section 420 so that a credit process, etc., is performed and only the downloading by the reader 200 by which a payment is guaranteed is permitted.

The database section 430 of the presentation material publishing server 400 comprises a presenter information database 431, a reader information database 432, a public information database 433, and a presentation material database 434.

The presenter information database 431 manages the registration information of the presenter 100, which is one of the users of the presentation material publishing services according to this embodiment. As will be described later, the registration information of the presenter 100 managed by the presenter information database 431 is set in a manner of two steps according to the degree of depth of use of the presentation material publishing services according to this embodiment. The primary registration information is a membership registration requested by an entrance section in order to receive an estimate service, etc., from the presentation material publishing server 400 according to this embodiment. Here, basic data, such as the address and the name, is acquired and managed. The secondary registration information is registration information which is requested during a temporary order-receiving when the presentation material publishing services are actually used. Here, information about credit information and electronic settlement information, etc., is acquired and managed.

The reader information database 432 manages the registration information of the reader 200, which is the other user of the presentation material publishing services according to this embodiment. In the presentation material publishing services according to this embodiment, although the construction can be adopted such that the presentation materials uploaded from the presenter 100 are freely provided to the reader 200, the construction can also be adopted such that the downloading of the presentation materials is permitted on condition of the registration of predetermined reader information. In the case such as the latter, the registered information about the reader 200 is registered in this reader information database 432, whereby the registered information is managed.

In the public information database 433, public information by which the presenter 100 makes public the presentation materials in the presentation material publishing server 400 is stored. Examples of the public information include the publication period of the presentation materials, the category information of the presentation materials, and the downloading permission information of the reader.

In the presentation material database 434, the presentation materials which are uploaded into the presentation material publishing server 400 by the presenter 100 are stored and managed. When the reader 200 downloads the presentation materials, the reader 200 may access a predetermined address within the presentation material database 434 and download the registered presentation materials.

In the foregoing, the hardware configuration of the presentation material publishing services according to this embodiment has been described. However, the present invention is not limited to the above-described embodiment. In particular, in the construction of the presentation material publishing server 400, a plurality of functional blocks can be formed as one functional block, or one functional block can be formed as a plurality of functional blocks. It is understood that, naturally, the above is within the technical scope of the present invention.

(2) Processing Flow of Presentation Material Publishing Services

Next, the processing flow of presentation material publishing services performed by the above-described hardware configuration will be described.

(2-1) Flow of Presentation Material Publishing Services

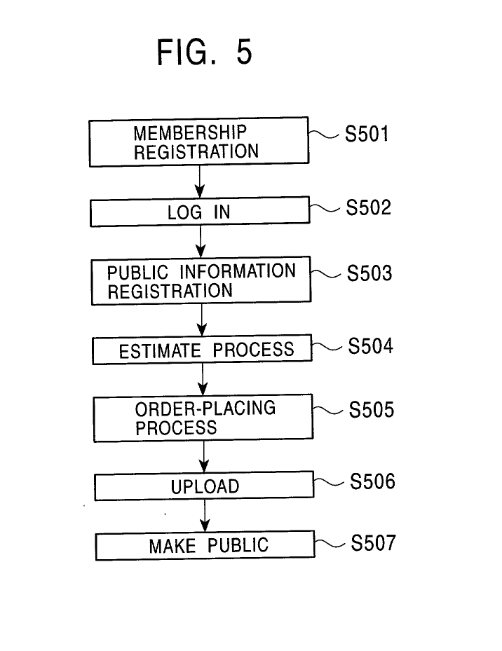

First, referring to FIG. 5, the outline of the processing flow of the presentation material publishing system according to this embodiment will be described.

Initially, in order that the client who has accessed the menu of the site managed by the presentation material publishing system according to this embodiment uses this system and receives the presentation material publishing services, a membership registration needs to be performed so that the client is authenticated as the presenter 100 (S501). In this manner, by permitting the use of the presentation material publishing site according to this embodiment on condition of the membership registration in advance, the number of accesses by nonserious users decreases, thus traffic congestion can be avoided.

As a result of performing a membership registration, the presenter 100 is assigned an ID and a password. In order that the presenter 100 which is authenticated as a member actually receives the presentation material publishing services according to this embodiment, it is necessary to log in to this service site from the menu screen (S502). When a log-in is performed, a public information registration screen is displayed on the screen of the presenter 100.

At this public information registration screen, the presenter 100 registers a presentation time, category information, downloading permission information, etc. (S503). When the public information is registered, an estimate process is performed on the basis of the registered information (S504). At the estimate screen, the presenter 100 confirms the cost necessary for uploading simulation materials into the presentation material publishing server 400 so that they are made public. If the presenter 100 consents to the cost, an order-placing process is performed at the order-placing screen (S505).

In the order-placing process, a credit check of the presenter 100 is performed. When the results of the credit check are approved, the uploading of the presentation materials is permitted (S506). The presenter 100 uploads the desired presentation materials into the presentation material publishing server 400, and the presentation material publishing server 400 makes public the uploaded presentation materials on the basis of the registered public information (S507).

(2-2) Flow of Order-Receiving Process

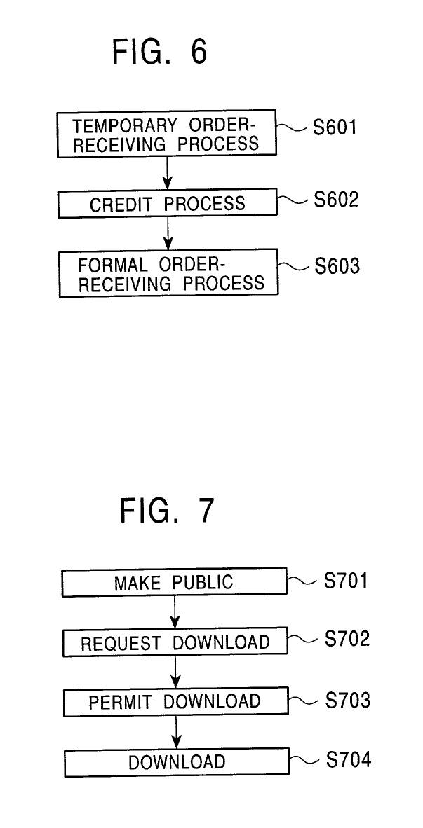

FIG. 6 shows the flow of the details of an order-receiving process performed in the presentation material publishing server 400 after the order-placing process is performed by the presenter 100.

As shown in FIG. 6, in the presentation material publishing services according to this embodiment, the order-receiving process is performed through a temporary order-receiving process (S601), a credit process (S602), and a formal order-receiving process (S603).

In the temporary order-receiving process (S601), an order from the presenter 100 is received, and the presenter 100 is prompted to register detailed information about the payment performance, such as a credit card number. A credit inquiry is performed on the registered detailed information in the following credit process (S602) so that the proof of the payment performance is checked. Only when the credit result is approved, the formal order-receiving process is performed (S603), and the uploading of the presentation materials is permitted.

In this manner, as a result of performing a credit process in this order-receiving process, the situation in which the presentation material publishing services are provided to the presenter 100 having no payment performance and the cost cannot be collected can be avoided.

Although this embodiment describes the construction in which an order-receiving process, including a credit process, is performed only when the presenter 100 uploads the presentation materials into the presentation material publishing server 400, of course, an order-receiving process, including a credit process, such as that shown in FIG. 6, can also be performed in the case where the reader 200 downloads the presentation materials from the presentation material publishing server 400.

(2-3) Flow of Presentation Material Downloading Process

Next, referring to FIG. 7, a description is given of the flow of the presentation material downloading process by the reader 200.

At a predetermined address which is set to the presentation material publishing server 400, the presentation materials uploaded by the presenter 100 are stored (S701). The reader 200 requests the downloading of the desired presentation materials when the reader 200 is informed of the URL for downloading the presentation materials which are made public by the presenter 100 or when the reader 200 arrives at the downloading URL which is classified according to the category information (S702). In the downloading permission section 422 of the presentation material publishing server 400, it is determined whether or not the reader 200 which has accessed the presentation materials has a download authority on the basis of the registered public information. When the reader 200 has a downloading authority, the downloading is permitted (S703). As a result, it becomes possible for the reader 200 to download the desired presentation materials and browse them.

(2-4) Management Structure of Presentation Materials

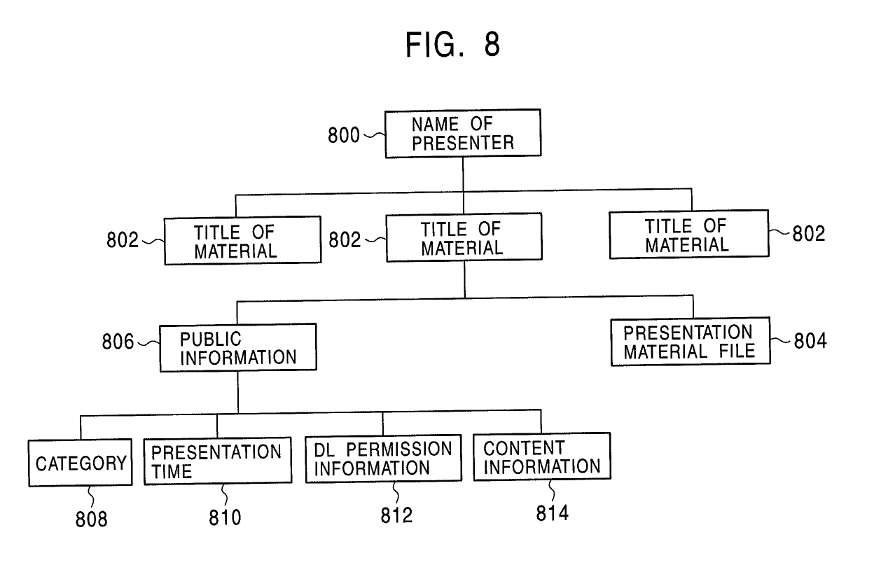

FIG. 8 shows an example of presentation material management in the presentation material publishing server 400.

As shown in FIG. 8, the presentation materials are managed for each presenter 100. In a case where the presenter 100 uploads a plurality of presentation materials as shown in FIG. 8, each presentation material is managed for each material title 802. Each presentation material is managed in such a way that a presentation material file 804 which is provided to the reader 200 is associated with public information 806 of the presentation materials. Furthermore, for the public information 806, a publication period 810, a category 808, downloading permission information 812, content information 814, etc., are registered individually. The presentation material publishing server 400 makes public the presentation material file 804 on the basis of the public information 806 which is registered herein.

Next, the presentation material publishing services according to this embodiment will be described in detail on the basis of the screen displayed on the display sections 102 and 202 of the presenter 100 and the reader 200, respectively.

(2-5) Screen Flow of Membership Registration Process

As has already been described, in order to receive the presentation material publishing services according to this embodiment, a registration as the presenter 100 must be completed in the menu page. In this manner, by making a membership registration necessary in advance, the number of accesses by an unserious user decreases, thus traffic congestion can be avoided.

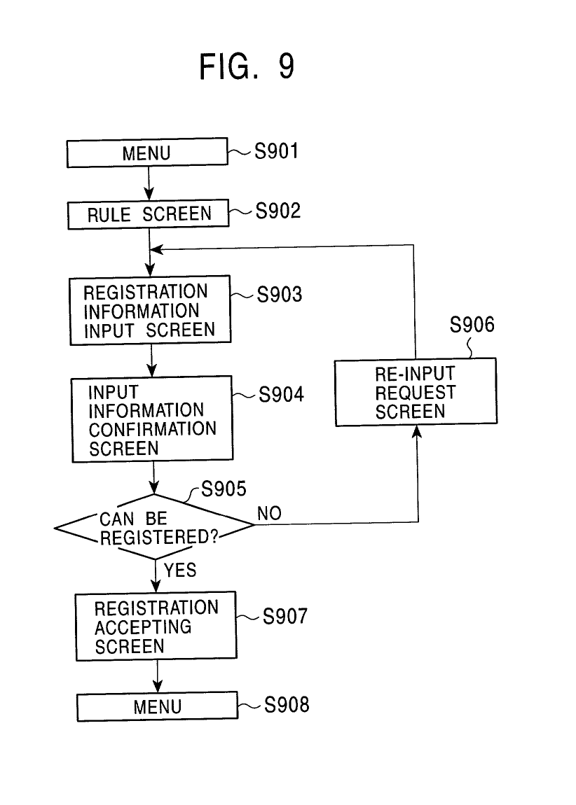

Referring to FIGS. 9 to 14, a screen flow of a typical membership registration process will be described in detail.

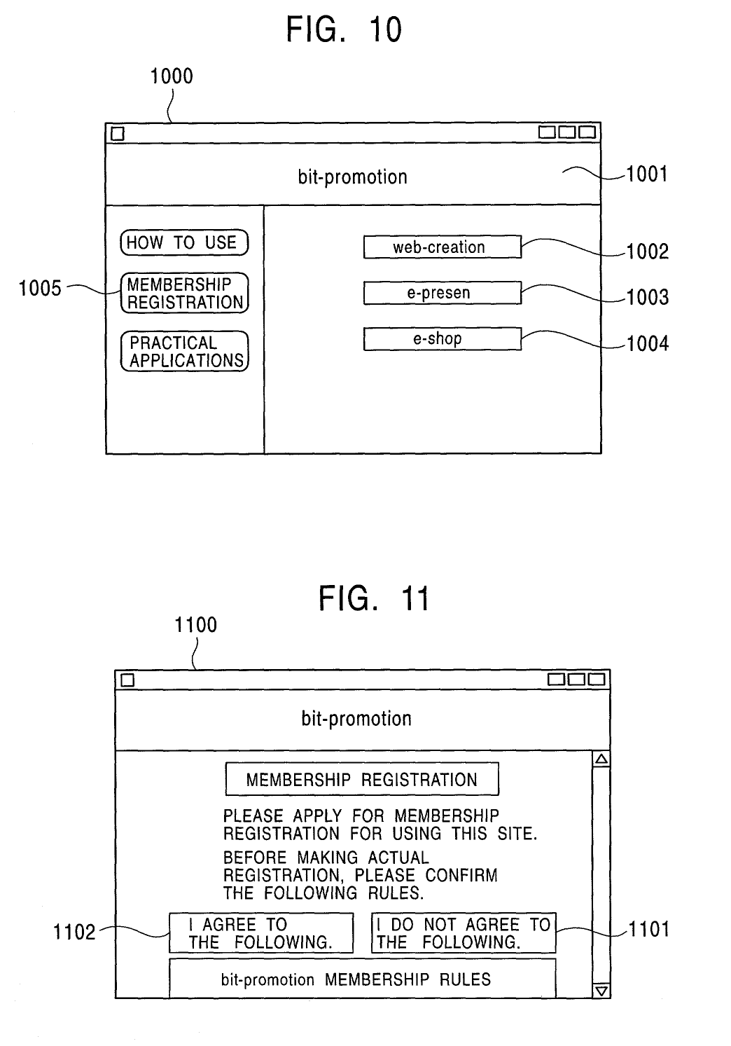

A menu page 1000 shown in FIG. 10 is formed as a comprehensive site 1001 formed of “bit-promotion” (S901). Inside this site, a plurality of individual services are expanded as subsites. In the example shown in FIG. 10, a “web-creation” 1002 is a subsite for providing Web page production assisting services. An “e-presen” 1003 is a subsite for providing presentation material publishing services according to this embodiment. An “e-shop” 1004 is a subsite for providing online shopping services. It becomes possible for the client to receive various services provided by the “bit-promotion” by performing a membership registration in the menu page.

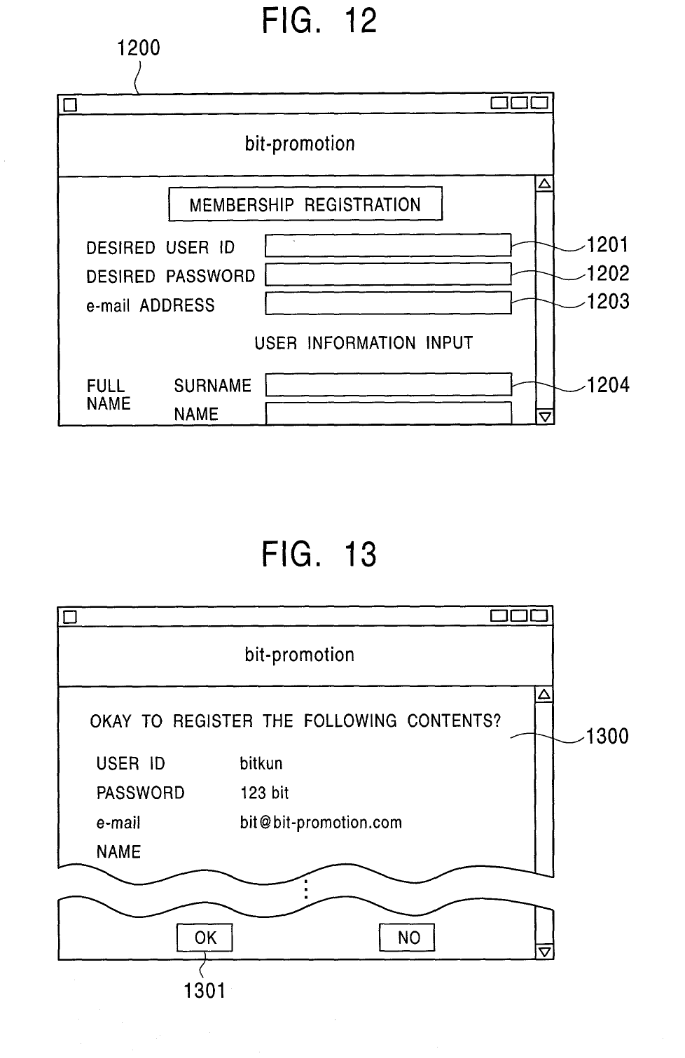

In this main menu page, when a membership registration button 1005 is depressed, a rule confirmation screen such as that shown in FIG. 11 is displayed (S902). In this rule confirmation screen 1100, consent matters 801 for using the presentation material publishing services according to this embodiment are displayed. In this rule confirmation screen 1100, as a result of depressing a consent button 1102 after the rules contents are confirmed, a membership registration information input screen 1200 such as that shown in FIG. 12 is displayed (S903).

On the membership registration information input screen 1200, for example, an input of membership registration information, such as a desired ID 1201, a desired password 1202, a mail address 1203, a name 1204, etc., is requested. On this membership registration information input screen 1200, when the input of the predetermined items is completed, an input information confirmation screen 1300 for prompting the presenter 100 to confirm the registered information is displayed (S904).

On this input information confirmation screen 1300, when a confirmation button 1301 is depressed after the input information is confirmed, the contents are transmitted to the presentation material publishing server 400. The presentation material publishing server 400 determines whether or not the contents of the transmitted registered information can be registered (S905).

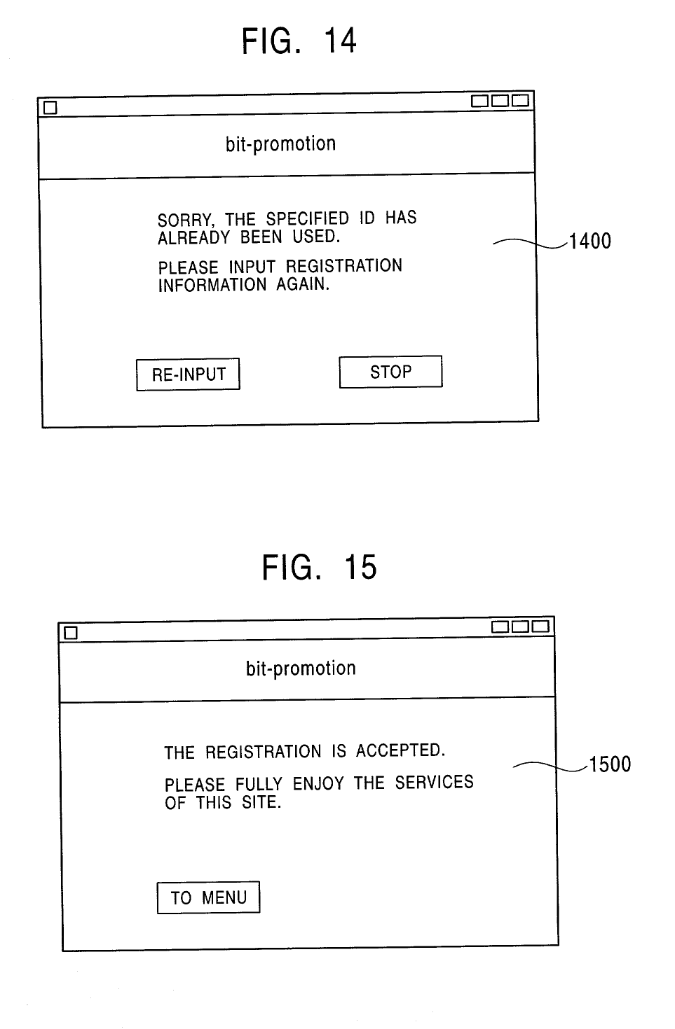

Then, when the contents of the transmitted registered information cannot be registered, for example, when the desired ID has already been used, as shown in FIG. 14, a screen 1400 for prompting a re-input of registration information is displayed (S906). In contrast, when the contents of the transmitted registered information can be registered, a registration completion notification screen 1500 such as that shown in FIG. 15 is displayed (S907), and the membership registration information input process is completed.

When the membership registration is completed, the authority for receiving the presentation material publishing services according to this embodiment is authenticated for the presenter 100, and the presenter 100 becomes possible to move to the subsite for providing the above-described services from the menu screen (S908).

(2-6) Flow of Presentation Material Uploading Screen

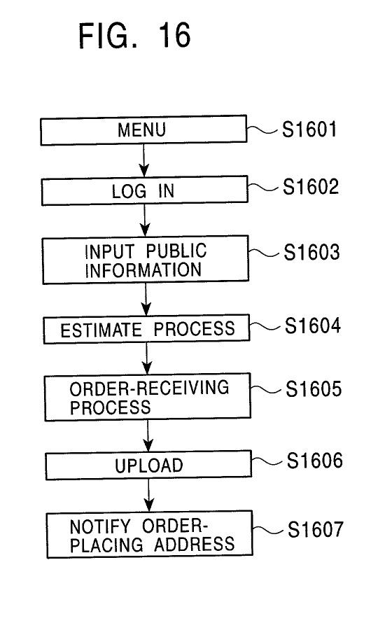

Next, referring to FIGS. 16 to 24, the flow of a presentation material uploading screen according to this embodiment is described.

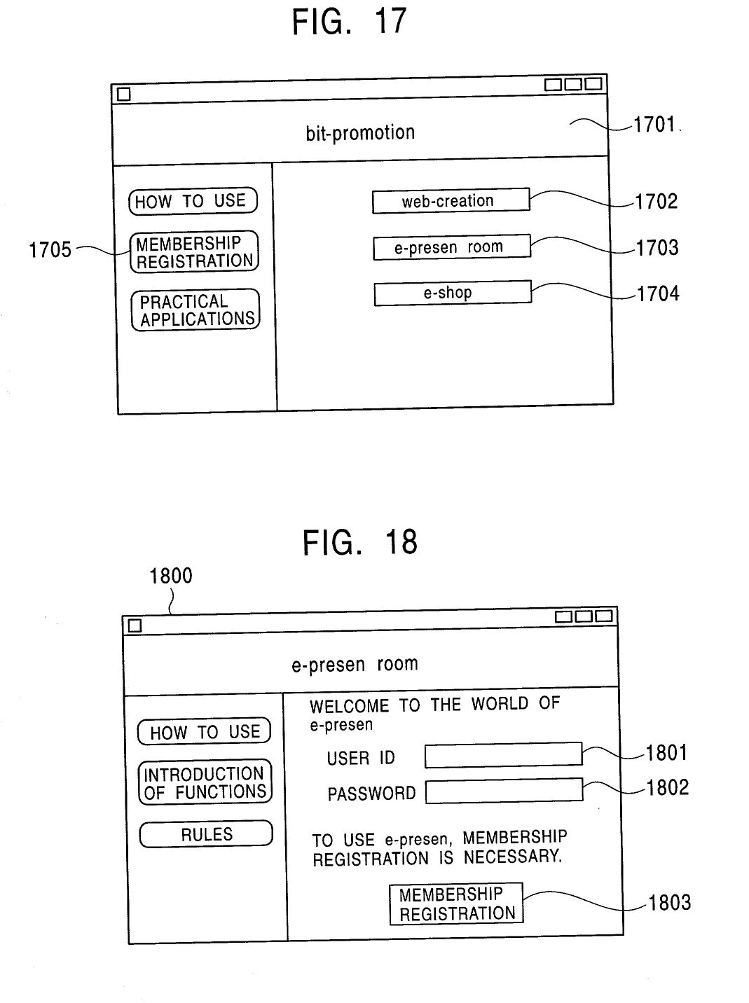

The menu page shown in FIG. 17 is substantially the same as a menu page 1500 shown in FIG. 10, and is formed as a comprehensive site 1701 formed of “bit-promotion” (S1601). Inside this site, a plurality of individual services are expanded as subsites. In the example shown in FIG. 17, a “web-creation” 1702 is a subsite for providing Web page production assisting services. An “e-presen” 1703 is a subsite for providing presentation material publishing services according to this embodiment. An “e-shop” 1704 is a subsite for providing online shopping services.

As has already been described, it is assumed that the presenter 100 has completed a membership registration in a membership registration site 1705 and has acquired a user ID and a password.

In FIG. 17, by depressing the “e-presen” 1703, the process moves to a log-in screen for entering the subsite for providing the presentation material publishing services according to this embodiment (S1602). FIG. 18 shows an example of a log-in screen 1800. In this log-in screen, by inputting a user ID 1801 and a password 1802, the process moves to a public information input screen for inputting public information (S1603). On the log-in screen 1800 shown in FIG. 18, a membership registration button 1803 which is linked to a membership registration site is also disposed, and it is also possible for the presenter 100 which has not yet acquired the user ID and the password to perform a membership registration from the membership registration button 1803.

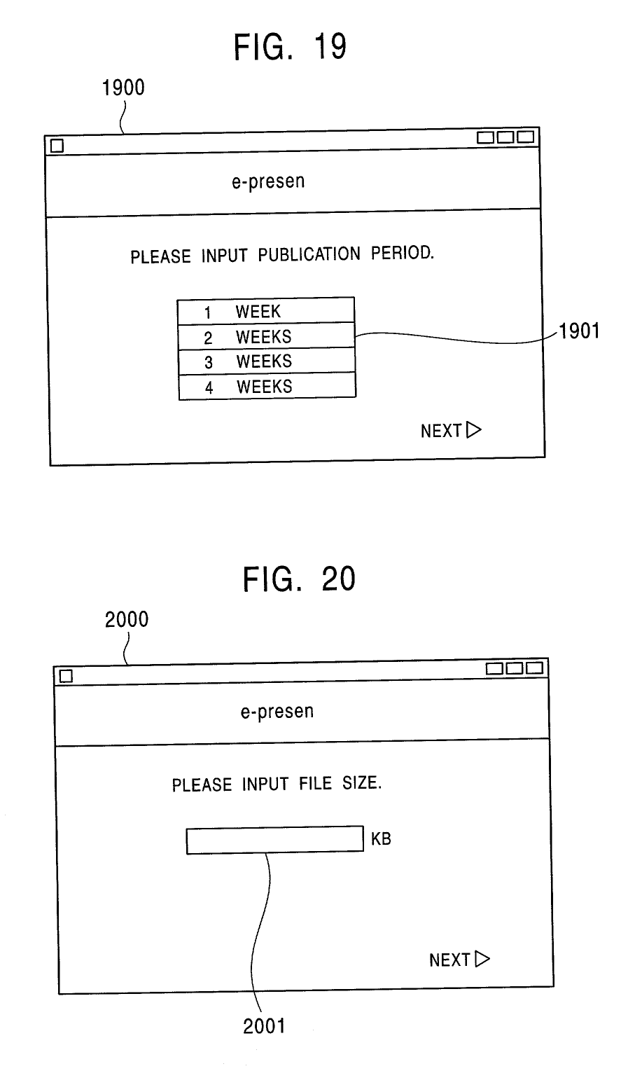

FIGS. 19 to 23 show an embodiment of a public information input screen.

FIG. 19 shows a publication period registration screen 1900 for selecting and inputting a publication period as one piece of public information of the presentation materials to be uploaded. The presenter 100 selects a publication period in which the presentation materials to be uploaded is presented from within a frame 1901 in which a plurality of publication periods is displayed.

FIG. 20 shows a file size registration screen 2000 for inputting the file size of the presentation materials as one piece of public information of the presentation materials to be uploaded. The presenter 100 inputs the file size of the presentation materials to be uploaded to a frame 2001. A certain degree of limitation is imposed on the size of the file which can be uploaded into the presentation material publishing server 400, and the uploading of a file which exceeds the limitation range is prohibited.

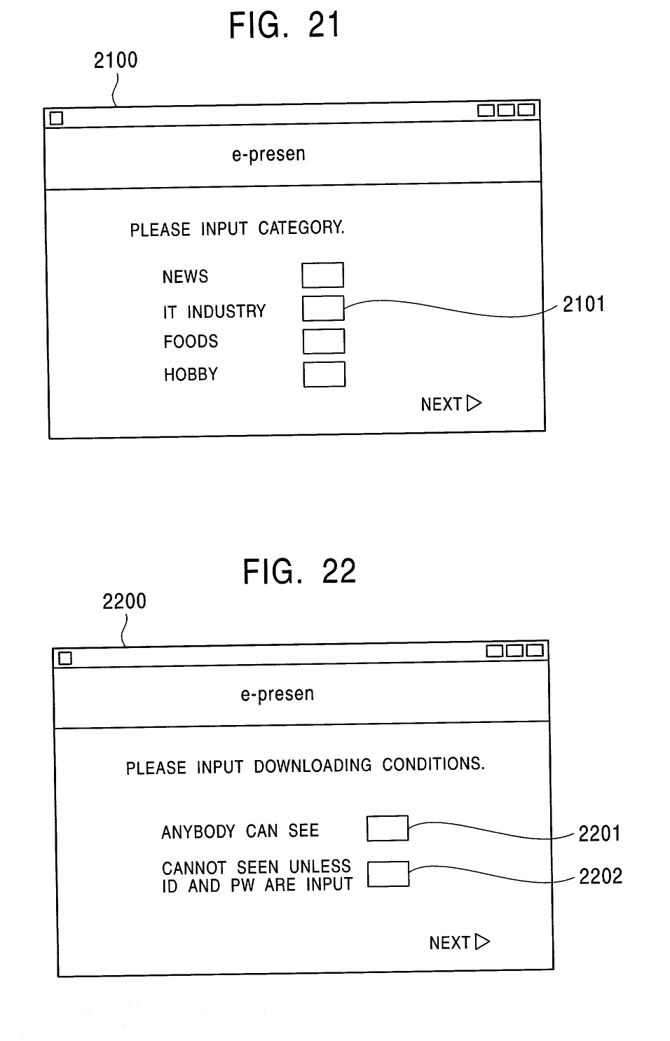

FIG. 21 shows a category information input screen 2100 for inputting the category information of the presentation materials as one piece of public information of the presentation materials to be uploaded. Although in the example shown in FIG. 21, category information is registered by selecting a category from among categories which are illustrated as examples in a list, of course, the construction may be formed in such a way that a category can be set freely.

FIG. 22 shows a downloading condition setting screen 2200 for setting downloading conditions of the presentation materials as one piece of public information of the presentation materials to be uploaded. When a downloading for all persons who have accessed the presentation materials to be uploaded is to be made possible, the presenter 100 selects a frame 2201. In contrast, when the reader 200 which can download the uploaded presentation materials is to be limited, a frame 2202 is selected, and the ID and the password are set. In this manner, if a limitation is set in the downloading, it becomes possible to distribute the presentation materials to only the reader 200 to which the presenter 100 has taught the ID and the password.

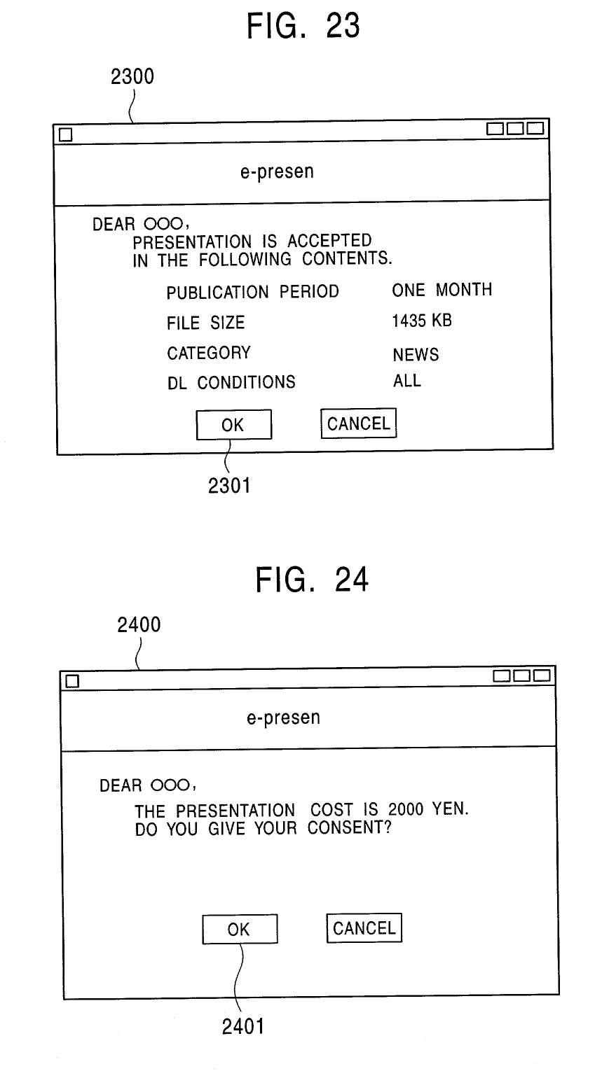

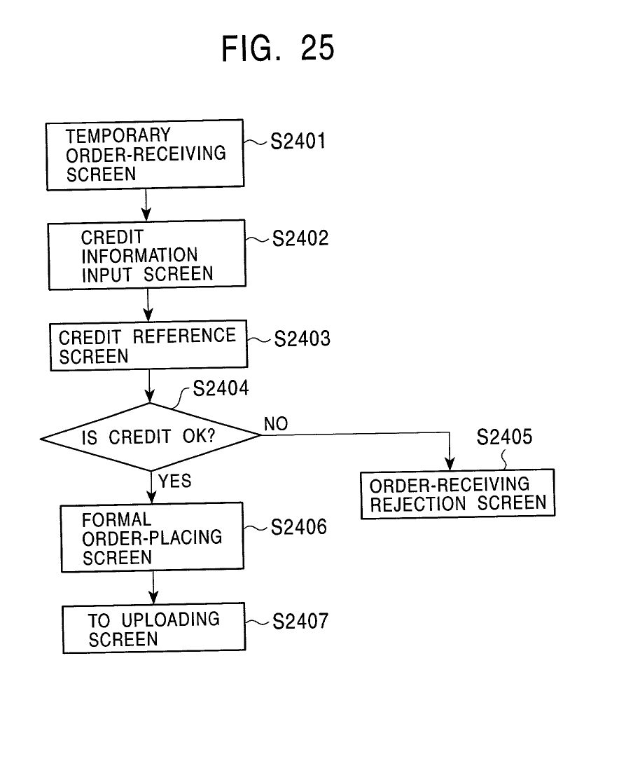

FIG. 23 shows, in a list, the public information that the presenter 100 has input on the screens shown in FIGS. 19 to 22. If the displayed public information is correct, the presenter 100 moves to the estimate screen shown in FIG. 24 by depressing an Ok button 2301.

FIG. 24 shows an estimate of the cost necessary for making the presentation materials public on the presentation material publishing server 400 in accordance with the public information registered by the presenter 100. When the presenter 100 consents to the displayed estimate money, an OK button 2401 is depressed.

(2-7) Flow of Order-Receiving Screen

Next, a description is given of an order-receiving process performed on the presentation material publishing server 400 side in a case where the presenter 100 confirms the estimate cost on the screen shown in FIG. 24 and orders an upload onto the presentation material publishing server 400 of the presentation materials.

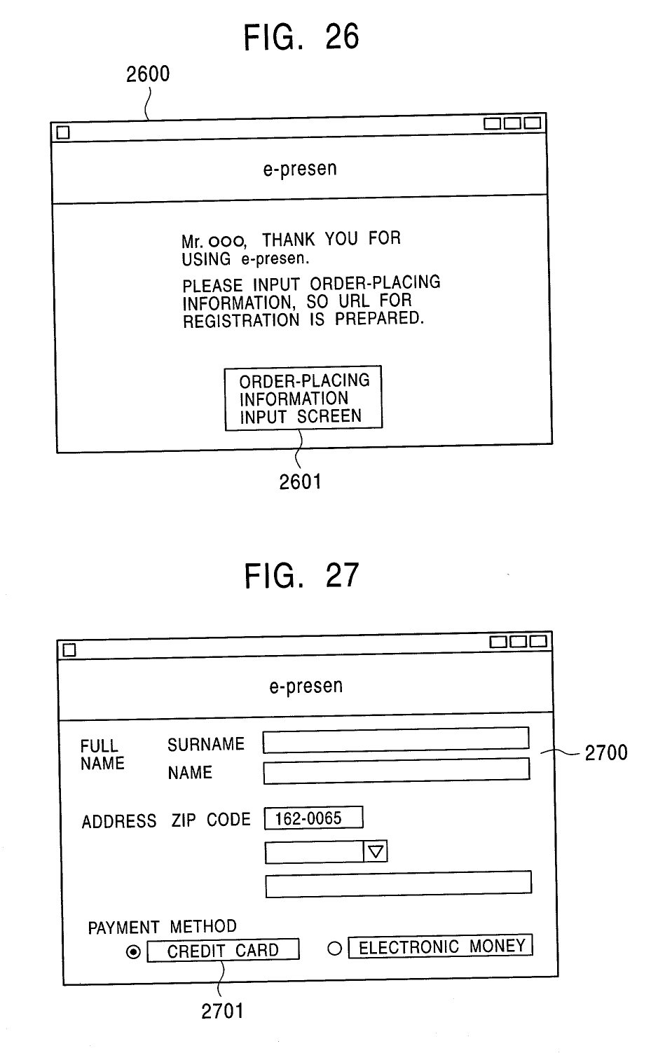

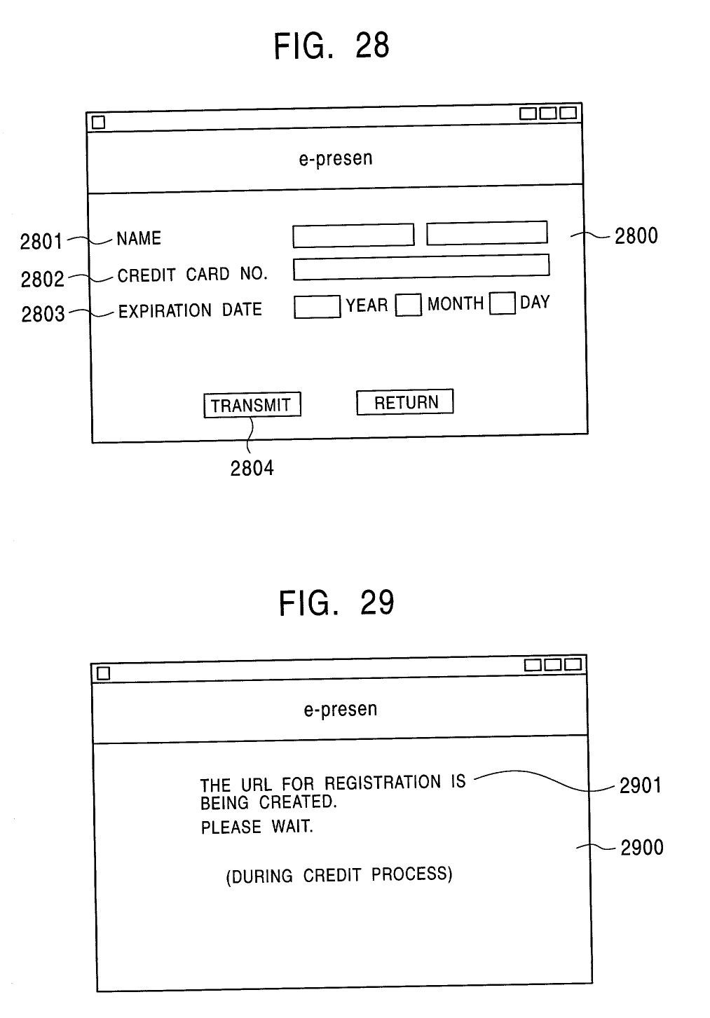

When an OK button (order-placing button) 2401 is depressed on the estimate screen 2400 shown in FIG. 24, a temporary order-placing screen 2600 such as that shown in FIG. 26 is displayed (S2401). Then, on this temporary order-placing screen 2600, when an order-placing information input screen button 2601 is depressed, the process moves to a settlement method confirmation screen 2700 for confirming the settlement method. On this settlement method confirmation screen 2700, membership information which is registered in advance is also displayed together. For example, on this settlement method confirmation screen 2700, when a credit card button 2702 is selected, a credit information input screen 2800 such as that shown in FIG. 28 is displayed (S2402).

Since the credit information input screen 2800 shown in FIG. 28 corresponds to credit card settlement, as credit information, an input of a credit card name 2801, a credit card number 2802, and a credit card expiration date 2803 is requested. After the presenter 100 inputs predetermined items on this credit information input screen 2800, the presenter 100 depresses a transmission button 2804 in order to transmit the credit information to the presentation material publishing server 400.

The presentation material publishing server 400 makes a credit inquiry of the presenter 100 on the basis of the transmitted credit information (S2404). The credit inquiry can be performed in such a way that, for example, credit information is transmitted to a credit server (not shown) formed as a server differing from the presentation material publishing server 400, credit inquiry is performed by the credit server, and the presentation material publishing server 400 is made to respond back the credit result.

Since the credit inquiry may take some time, in that case, as shown in FIG. 29, a message 2901 such as “the registration target URL is being created. Please wait.” is displayed on a screen 2900 indicating “during a credit inquiry”, thus the stress on the presenter 100 side can be lessened.

When the result of the credit inquiry is disapproved, such as the effective time of the credit card being expired, an order-receiving rejection screen (not shown) is displayed, and the downloading of layout information by the presenter 100 is rejected (S2405).

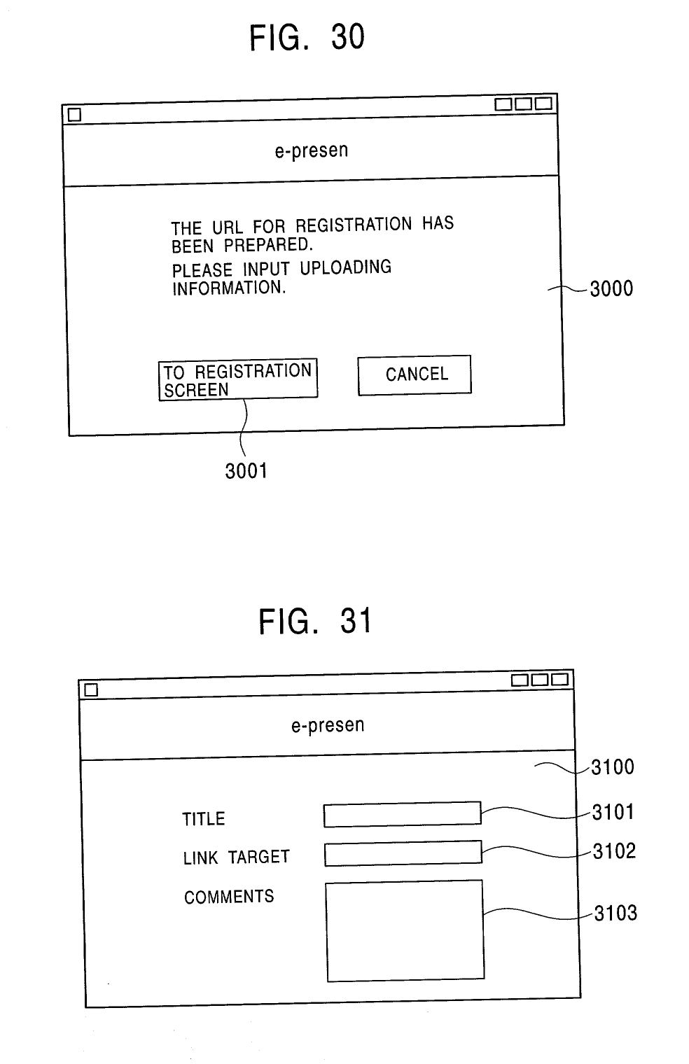

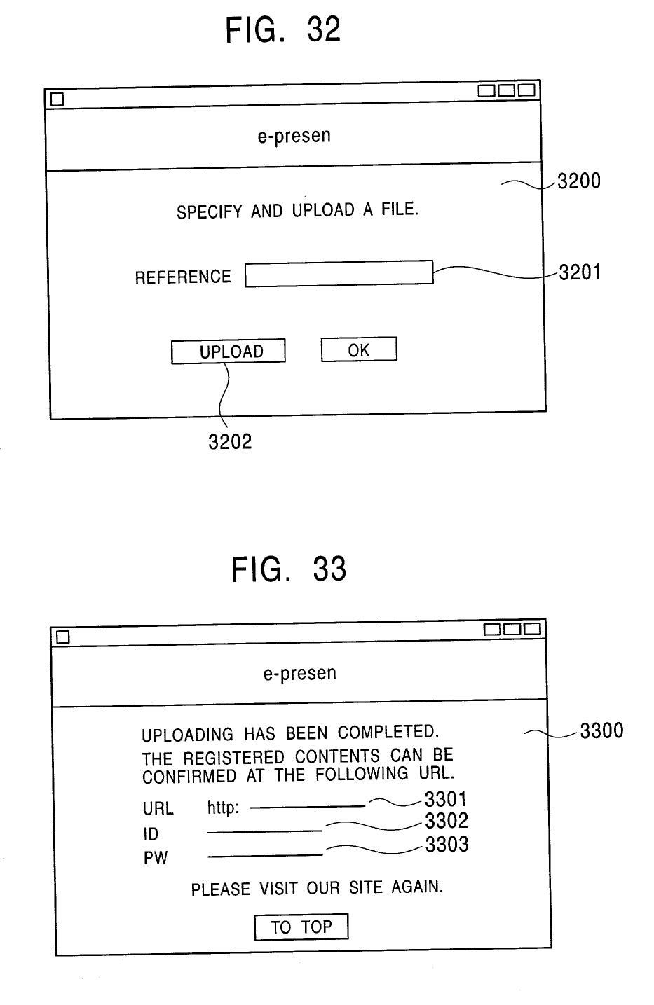

In contrast, when the credit inquiry is approved, as shown in FIG. 30, on the screen formed so as to prompt an input of upload information, a formal order-placing process is performed (S2406). Then, when the preparations of the registration target URL are complete, by depressing a “to registration screen” button 3001 displayed on a screen 3000 shown in FIG. 30, the process moves to an upload information registration screen such as that shown in FIG. 31 (S2407).

On an uploading screen 3100, an input of a title 3101 of the presentation materials to be uploaded, a link specification to a Web page associated with the presentation materials, comments 3103 relating to the presentation materials, etc., can be made.

When the upload information is input on the uploading screen 3100, the process moves to a file specification screen 3200. On this file specification screen 3200, a file name 3201 of the presentation materials to be uploaded is specified. Then, after the file name 3201 is specified on this file specification screen 3200, when an upload button 3202 is depressed, the upload is performed.

FIG. 33 shows an upload completion screen 3300. On this upload completion screen 3300, the presenter 100 is notified of the URL of the folder where the presentation materials are stored, and the ID and the password for downloading the presentation materials and browsing them.

(2-8) Flow of Presentation Material Downloading

In the presentation material publishing services according to this embodiment, various methods for downloading the presentation materials by the reader 200 can be set. For example, the construction may be formed in such a way that the presenter 100 notifies the downloading target URL to the reader 200 that the presenter 100 wants the presentation materials to be downloaded, and the reader 200 directly accesses the downloading target URL so as to download the desired presentation materials.

Alternatively, the construction may be formed in such a way that the reader 200 retrieves the desired presentation materials and download them. In such a case, the construction may be formed in such a way that the reader 200 accesses a downloading site 3400 such as that shown in FIG. 34, selects a desired category from among category buttons 3401 to 3404 which are illustrated as examples in the downloading site 3400, and arrives at the desired presentation materials.

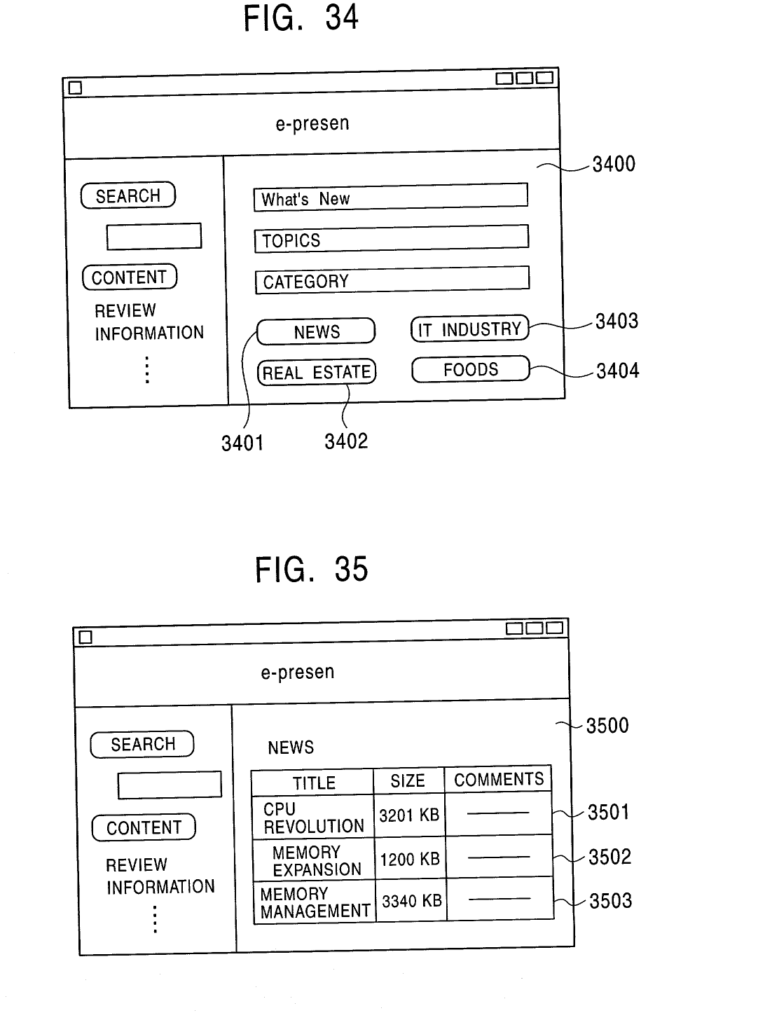

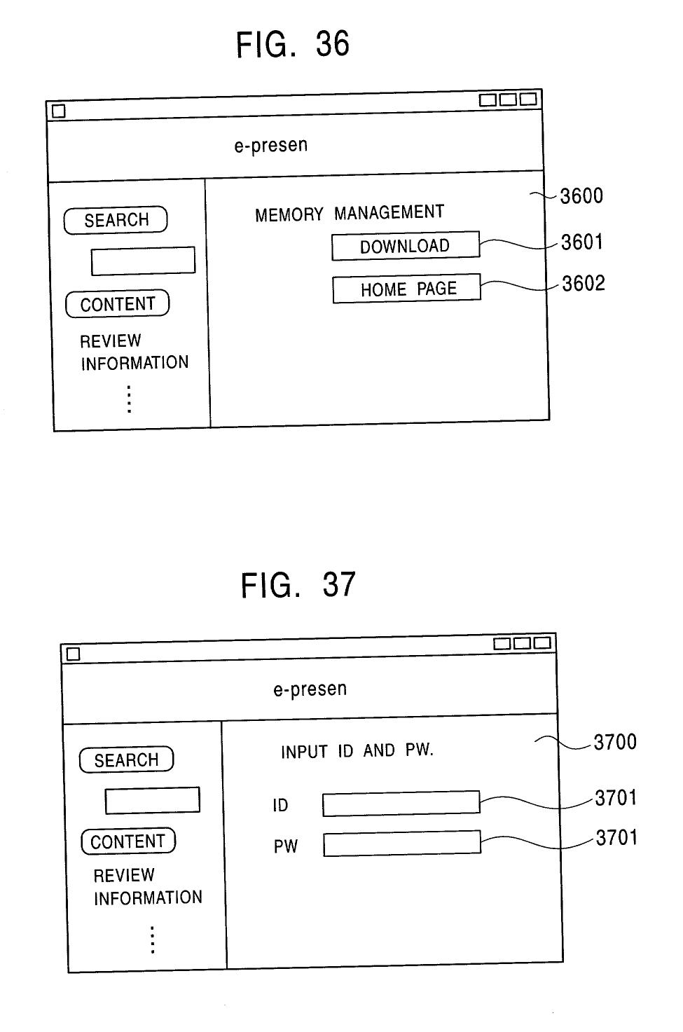

For example, in the downloading site 3400 shown in FIG. 34, when a new product news button 3401 is depressed, a table 3501 to 3503 of the downloadable presentation materials is displayed on a new product news screen 3500 such as that shown in FIG. 35. The reader 200 selects the presentation materials which are desired to be downloaded from the table. For example, on the new product news screen 3500 shown in FIG. 35, when a “memory management” 3503 is selected, the process moves to a downloading screen 3600 of the presentation materials relating to the “memory management”, as shown in FIG. 36.

Then, on this downloading screen 3600, by depressing a downloading button 3601, it becomes possible to download the presentation materials. On the downloading screen 3600 shown in FIG. 36, a link button 3602 to a related Web page is also displayed.

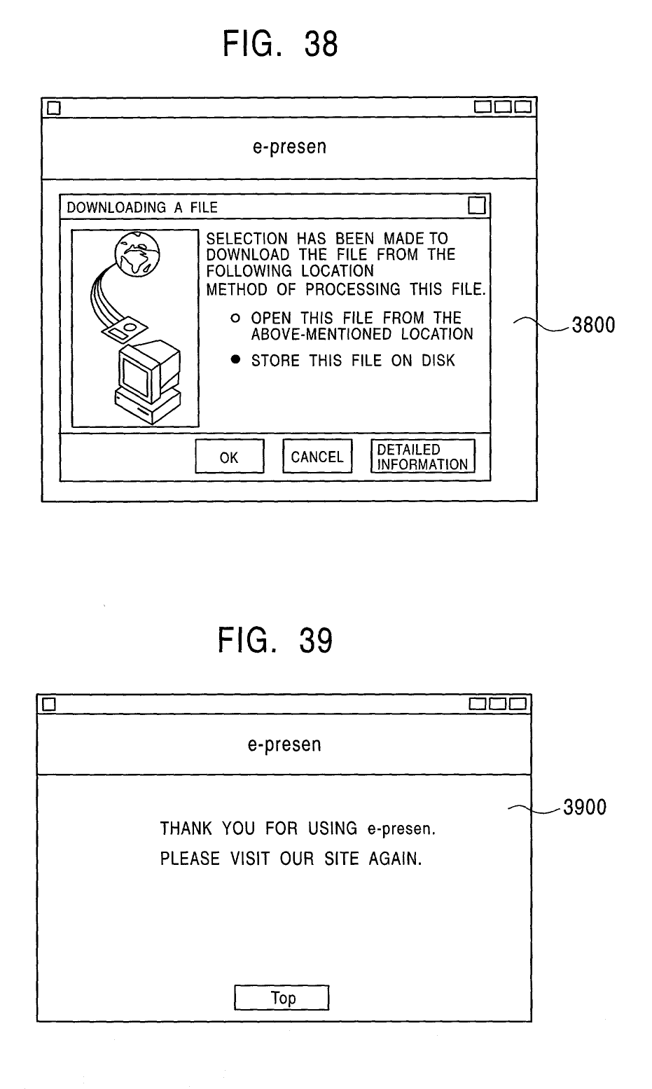

On the downloading screen 3600 of FIG. 36, when the downloading button 3601 is depressed, if the downloading conditions are not particularly set as public information, the process immediately moves to a downloading screen 3800 such as that shown in FIG. 38, and a downloading process is performed. In comparison, when the downloading conditions are set as public information, on the downloading screen 3600 of FIG. 36, when the downloading button 3601 is depressed, a log-in screen 3700 such as that shown in FIG. 37 is displayed.

On the log-in screen 3700 shown in FIG. 37, when an appropriate ID 3701 and an appropriate password 3702 are input, the process moves to a downloading screen 3800 such as that shown in FIG. 38. As a result, on the downloading screen shown in FIG. 38, a “downloading a file” screen 3800 of a window showing this state is displayed, and a downloading process is performed.

After the downloading is completed, a screen for showing thanks to the use of the presentation material creation assisting services according to this embodiment, such as that shown in FIG. 39 is displayed, and a series of operations is terminated.

The file which is downloaded to the presenter 100 is merged by using an appropriate presentation tool, and can be used for actual presentations. Since a method of merging files by a presentation tool such as PowerPoint is well known, it is only briefly mentioned in the specification, and a detailed description thereof is omitted.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A presentation material publishing system comprising:
a presenter;
a reader; and
a presentation material publishing server which can be accessed by said presenter and said reader via a network,
wherein said presentation material publishing server can store presentation materials uploaded from said presenter via said network in such a manner as to be associated with public information, and has the right to permit the browsing of said presentation materials by said reader which has accessed them via said network,
said presenter can register predetermined public information in said presentation material publishing server via said network and can upload said presentation materials in such a manner as to be associated with said public information, and
said reader can browse the presentation materials permitted by said presentation material publishing server via said network.

2. A presentation material publishing system according to claim 1, wherein, in said presentation material publishing server, the uploading of said presentation information by said presenter is not permitted until the public information is registered from said presenter.

3. A presentation material publishing system according to claim 1, wherein, in said presentation material publishing server, the uploading of said presentation information by said presenter is not permitted until the user registration of a presenter user is performed from said presenter.

4. A presentation material publishing system according to claim 1, wherein said public information contains at least a publication period of said presentation materials, and the browsing of said presentation materials by said reader is permitted only in that publication period.

5. A presentation material publishing system according to claim 1, wherein said public information contains at least category information of said presentation materials, and said presentation materials are classified according to said category information and are made public.

6. A presentation material publishing system according to claim 1, wherein said public information contains browsing permission information of said reader, and only the browsing of said presentation materials by said reader that matches browsing permission conditions is permitted.

7. A presentation material publishing system according to claim 1, wherein said presentation material publishing server notifies said presenter of estimate information on the basis of the public information registered by said presenter.

8. A presentation material publishing system according to claim 1, wherein said presentation material publishing server performs a credit process of said presenter before the uploading of said presentation materials by said presenter is performed, and when said credit process is not approved, the uploading of said presentation materials by said presenter is not permitted.

9. A presentation material publishing system according to claim 8, wherein only when said uploading of said presentation materials is permitted, the uploading target address is notified to said presenter.

10. A presentation material publishing server comprising:
a storage device capable of storing presentation materials uploaded from a presenter via a network in such a manner as to be associated with public information; and
a browsing permission device having the right to permit the browsing of said presentation materials by a reader which has accessed them via a network.

11. A presentation material publishing server according to claim 10, wherein the uploading of said presentation materials by said presenter is not permitted until the public information is registered from said presenter.

12. A presentation material publishing server according to claim 10, wherein the uploading of said presentation materials by said presenter is not permitted until a user registration of a presenter user is registered from said presenter.

13. A presentation material publishing server according to claim 10, wherein said public information contains at least a publication period of said presentation materials, and the browsing of said presentation materials by said reader is permitted only in that publication period.

14. A presentation material publishing server according to claim 10, wherein said public information contains at least category information of said presentation materials, and said presentation materials are classified according to said category information and are made public.

15. A presentation material publishing server according to claim 10, wherein said public information contains browsing permission information of said reader, and only the browsing of said presentation materials by said reader that matches browsing permission conditions is permitted.

16. A presentation material publishing server according to claim 10, further comprising an estimate device for notifying said presenter of estimate information on the basis of the public information registered by said presenter.

17. A presentation material publishing server according to claim 10, further comprising a credit device for performing a credit process of said presenter before the uploading of said presentation materials by said presenter is performed, and when said credit process is not approved, the uploading of said presentation materials by said presenter is not permitted.

18. A presentation material publishing server according to claim 17, further comprising an address notification device for notifying the uploading target address of said presentation materials, and only when said uploading of said presentation materials is permitted, the uploading target address is notified to said presenter.

19. A presentation material publishing program storage medium by which a computer forms the presentation material publishing server according to claim 10.

20. A presentation material publishing program by which a computer forms the presentation material publishing server according to claim 10.

21. A presentation material publishing method comprising:
a step in which a presenter accesses a presentation material publishing server via a network and uploads presentation materials to said presentation material publishing server via said network;
a step of storing said uploaded presentation materials in such a manner as to be associated with public information; and
a step of permitting the browsing of the presentation materials by a reader which has accessed said presentation material publishing server via said network.

22. A presentation material publishing method according to claim 21, wherein, in said presentation material publishing server, the uploading of said presentation information by said presenter is not permitted until the public information is registered from said presenter.

23. A presentation material publishing method according to claim 21, wherein, in said presentation material publishing server, the uploading of said presentation information by said presenter is not permitted until the user registration of a presenter user is performed from said presenter.

24. A presentation material publishing method according to claim 21, wherein said public information contains at least a publication period of said presentation materials, and the browsing of said presentation materials by said reader is permitted only in that publication period.

25. A presentation material publishing method according to claim 21, wherein said public information contains at least category information of said presentation materials, and said presentation materials are classified according to said category information and are made public.

26. A presentation material publishing method according to claim 21, wherein said public information contains browsing permission information of said reader, and only the browsing of said presentation materials by said reader that matches browsing permission conditions is permitted.

27. A presentation material publishing method according to claim 21, wherein said presentation material publishing server notifies said presenter of estimate information on the basis of the public information registered by said presenter.

28. A presentation material publishing method according to claim 21, wherein said presentation material publishing server performs a credit process of said presenter before the uploading of said presentation materials by said presenter is performed, and when said credit process is not approved, the uploading of said presentation materials by said presenter is not permitted.

29. A presentation material publishing method according to claim 21, wherein only when said uploading of said presentation materials is permitted, the uploading target address is notified to said presenter.
